(19) United States
(12) Patent Application Publication
(10) Pub. No.: US 2009/0217222 A1
(43) Pub. Date: Aug. 27, 2009

(54) SEMICONDUCTOR INTEGRATED CIRCUIT

(75) Inventors: Shinichi Yasuda, Kawasaki-Shi (JP); Kumiko Nomura, Tokyo (JP); Keiko Abe, Yokohama-Shi (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/211,842

(22) Filed: Sep. 17, 2008

(30) Foreign Application Priority Data
Feb. 26, 2008 (JP) 2008-44475

(51) Int. Cl. G06F 17/50

(52) U.S. Cl. 716/4

(57) ABSTRACT

A semiconductor integrated circuit includes: a plurality of processor elements each including a test circuit which tests whether there is a failure in the processor element and outputs a result of the test; a plurality of switch boxes provided so as to be respectively associated with processor elements, each of the switch boxes configured to have a table to store information of another processor element and transmit information of a corresponding processor element to the other processor element based on information stored in the table; a plurality of identification circuits provided so as to be respectively associated with processor elements, each of the identification circuits configured to identify a defective processor element on the basis of the result of the test and output location information of the defective processor element; and a transmission circuit configured to transmit the location information of the defective processor element output from the identification circuit to the switch boxes.

### CROSS-REFERENCE TO RELATED APPLICATION

This application is based upon and claims the benefit of priority from prior Japanese Patent Application No. 2008-44475 filed on Feb. 26, 2008 in Japan, the entire contents of which are incorporated herein by reference.

### BACKGROUND OF THE INVENTION

1. Field of the Invention

The present invention relates to a semiconductor integrated circuit.

2. Related Art

As the integration in the semiconductor system advances and the number of elements included in one chip increases, there is a fear that events including defects and events from which defects are generated will increase. In such a large scale system, it also becomes difficult to inspect the whole system. Therefore, it is desirable that a function of inspecting whether there is a defect on a chip and a function of operating the system even if there is a defect are built into the semiconductor system. For implementing it in a multi-processor system having a plurality of processors on one system, it becomes necessary for processors to know whether there is a failure each other. Especially in a network-on-chip system formed on one chip in which elements on a system including a processor, a memory and I/Os are connected in a network form, mutual address information tables retained by respective elements must share defect information.

As methods for processors in a multiprocessor system to share defect information, there are, for example, methods disclosed in JP-A 5-233580 (KOKAI) and JP-A 2001-22599 (KOKAI). In the method described in JP-A 5-233580 (KOKAI), each processor performs a failure detection test. If a failure is detected, its information is recorded in a failure table included in each processor and a service processor collects and records the information. In the method described in JP-A-2001-22599 (KOKAI), each processor has a device for failure detection. If a failure is detected, the processor notifies other processors thereof, and each processor refers to a reconfiguration table.

The configurations described in JP-A 5-233580 (KOKAI) and JP-A 2001-22599 have a problem that it takes a time for the processors to share failure information. If it is attempted to apply it to a network-on-chip system, there is a possibility that a different processor element might send information to a failure processor while performing communication of failure information, resulting in a problem of tolerance to failures.

### SUMMARY OF THE INVENTION

The present invention has been made in view of these circumstances, and an object thereof is to provide a semiconductor integrated circuit capable of shortening time required to share failure information as far as possible.

A semiconductor integrated circuit according to a first aspect of the present invention includes: a plurality of processor elements each including a test circuit which tests whether there is a failure in the processor element and outputs a result of the test; a plurality of switch boxes provided so as to be respectively associated with processor elements, each of the switch boxes configured to have a table to store information of another processor element and transmit information of a corresponding processor element to the other processor element based on information stored in the table; a plurality of identification circuits provided so as to be respectively associated with processor elements, each of the identification circuits configured to identify a defective processor element on the basis of the result of the test and output location information of the defective processor element; and a transmission circuit configured to transmit the location information of the defective processor element output from the identification circuit to the switch boxes.

A semiconductor integrated circuit according to a second aspect of the present invention includes: a plurality of processor elements each including a test circuit which tests whether there is a failure in the processor element and outputs a result of the test; and a plurality of switch boxes provided so as to be respectively associated with the processor elements, each of the switch boxes configured to include a table to store information of all of the processor elements and an identification circuit to identify a defective processor element based on the results of the tests of all the test circuits and send information of the defective processor element to the tables, and each of the switch boxes configured to transmit information of a corresponding processor element to other processor elements based on information stored in the table.

### BRIEF DESCRIPTION OF THE DRAWINGS

FIG. 1 is a schematic diagram showing a semiconductor integrated circuit according to a first embodiment;

FIG. 2 is a block diagram showing a processor element according to the first embodiment;

FIG. 3 is a block diagram showing a test circuit for the processor element according to the first embodiment;

FIG. 4 is a block diagram showing a switch box according to the first embodiment;

FIG. 5 is a diagram showing a network-on-chip;

FIG. 6 is a circuit diagram showing a circuit for identifying a defective processor element;

FIG. 7 is a diagram for explaining an operation of the test circuit;

FIG. 8 is a block diagram showing a transmission circuit;

FIG. 9 is a diagram showing an example of an address inverse translation table;

FIG. 10 is a diagram showing an example of a circuit which provides tolerance to failures of a plurality of processor elements;

FIG. 11 is a diagram showing another example of a circuit which provides tolerance to failures of a plurality of processor elements;

FIG. 12 is a schematic diagram showing a semiconductor integrated circuit according to a second embodiment;

FIG. 13 is a diagram showing an example of an address table in the second embodiment;

FIG. 14 is a circuit diagram showing a circuit for implementing the address table shown in FIG. 13; and

FIG. 15 is a circuit diagram showing another specific example of a flag bit generation circuit.

### DETAILED DESCRIPTION OF THE INVENTION

Hereafter, embodiments of the present invention will be described in detail with reference to the drawings.

### First Embodiment

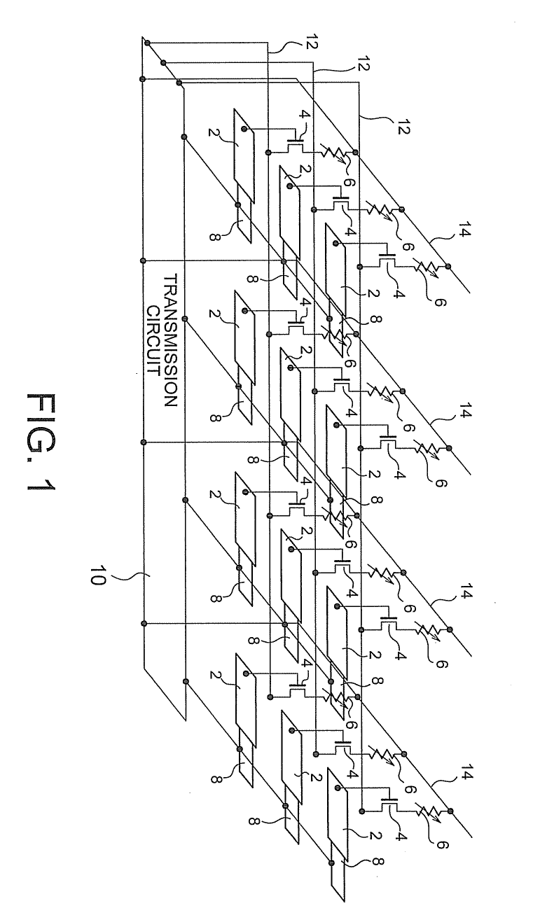

A semiconductor integrated circuit according to a first embodiment of the present invention is shown in FIG. 1. FIG. 1 is a three-dimensional schematic diagram showing a semiconductor integrated circuit according to the present embodiment. A plurality of processor elements 2 are arranged on one chip. A selection transistor 4 and a memory element 6 formed of a fuse or a variable resistor are disposed right over each processor element 2. The selection transistor 4 and the memory element 6 are connected in series, and electrically connected to a corresponding processor element 2. By the way, the selection transistor 4 and the memory element 6 need not be disposed right over three-dimensionally. As long as the selection transistor 4 and the memory element 6 are disposed so as to be associated with each processor element 2 in one-to-one correspondence and electrically connected to the processor element 2, it doesn't matter where the selection transistor 4 and the memory element 6 are placed. If the selection transistor 4 and the memory element 6 are three-dimensionally disposed right over each processor element 2 as shown in FIG. 1, however, there is an advantage that the circuit area is reduced and association with a defective processor element 2 can be easily grasped. In FIG. 1, processor elements 2, selection transistors 4 and memory elements 6 are arranged in a matrix form. In the actual chip, however, the processor elements are not arranged in a matrix form. In the present embodiment, therefore, the processors 2 are virtually arranged in a matrix form so as to be able to specify a position of each processor element 2 from row information (an X coordinate) and column information (a Y coordinate) based on this arrangement. In other words, the row information (the X coordinate) and column information (the Y coordinate) constitute position information of the processor element 2. FIG. 1 shows a circuit diagram based on the virtual arrangement. Herein, the processor element means a processor, a memory, an interface circuit, a logic circuit or the like.

Furthermore, in the present embodiment, each processor element 2 is electrically connected to a switch box 8 which selects a route to perform communication with another processor element 2. However, the processor element 2 and the switch box 8 need not always be connected in one-to-one correspondence. One terminal of the selection transistor 4 (a terminal which is not connected to the memory element 6) and one terminal of the memory element 6 (a terminal which is not connected to the selection transistor 4) are respectively connected to wires 12 and 14 as shown in FIG. 1. The wire 12 connects to the selection transistor 4 of processor elements 2 which belong to the same row (or the same column) when arranged virtually as described above, and the wire 14 connects to the memory element 6 of processor elements 2 which belong to the same column (or the same row) when arranged virtually as described above. These wires 12 and 14 are connected to a transmission circuit 10. Since information obtained from the memory element 6 is position information itself of a defective processor element 2, the transmission circuit 10 translates this position information to address information to be used in an address table which is included in the switch box 8 and which will be described later, and transmits the address information to the address table in each switch box 8 collectively.

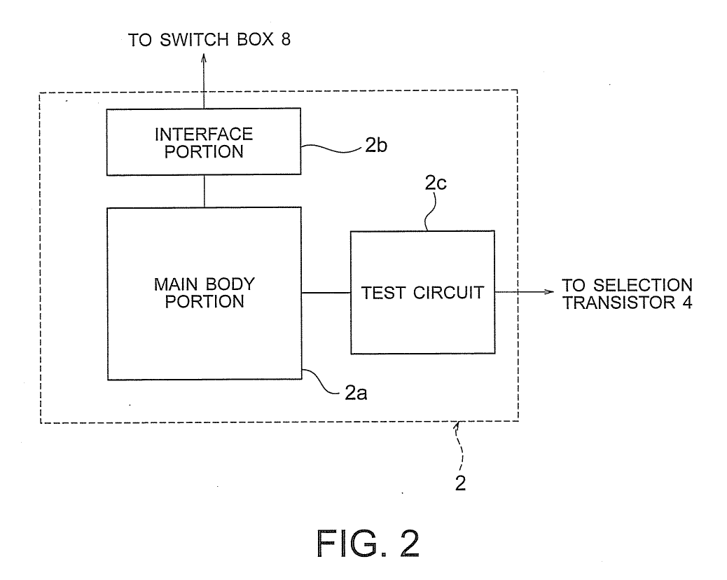

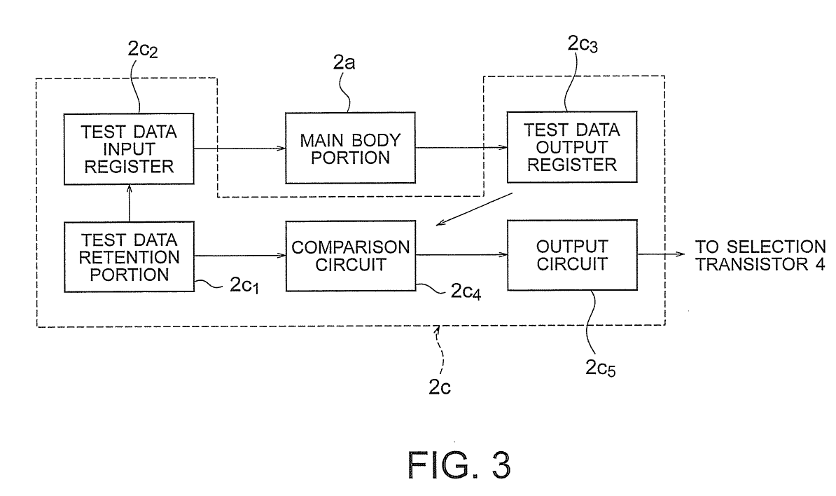

As shown in FIG. 2, each processor element 2 includes a main body portion 2a formed of a processor, a memory, an interface circuit or an arbitrary logic circuit, an interface portion 2b serving as an interface to the switch box 8, and a test circuit 2c for testing whether there is a failure of the processor element 2 itself. As shown in FIG. 3, the test circuit 2c includes a test data retention portion 2c₁, a test data input register 2c₂, a test data output register 2c₃, a comparison circuit 2c₄, and an output circuit 2c₅. This test circuit 2c starts the test of the processor element 2 itself in response to a failure detection instruction sent from the outside of the chip. In other words, upon receiving the failure detection instruction, test data is sent from the test data retention portion 2c₁ which retains the test data to the test data input register 2c₂ and stored therein. In addition, when the test data is input to the processor element 2, a value (expected value) expected to be output from the processor element 2 when the processor element 2 is normal is sent to the comparison circuit 2c₄. Thereafter, the test data is sent from the test data input register 2c₂ to the main body portion 2a. And output data from the main body portion 2a based upon the test data is sent to the test data output register 2c₃ and stored therein. The output data stored in the test data output register 2c₃ is sent to the comparison circuit 2c₄ and compared with the expected value. If the output data is the same as the expected value, the main body portion 2a judges that there is no problem. If the output data is different from the expected value, the main body portion 2a judges that there is a problem in the main body portion 2a. The result of the comparison is output to the selection transistor 4 via the output circuit 2c₅. For example, if there is no problem in the main body portion 2a in the processor element 2, a value “1” is output to the outside. If there is any problem, a value is not output and the value is made to remain “0.” As a matter of course, it is not restrictive.

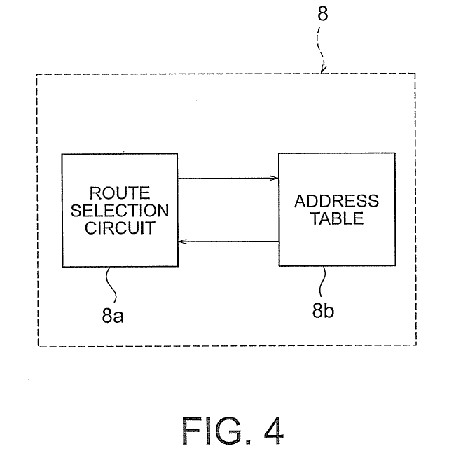

As shown in FIG. 4, the switch box 8 includes a route selection circuit 8a which selects a route for sending information such as a computation result or an instruction to another switch box 8, i.e., to another processor element 2, and an address table 8b in which address information of a processor element 2 serving as destination is recorded. Information sent via the route is sent as packet data. Upon receiving the packet data, the processor element 2 transmits address information contained in the packet data to an address table 8b in a switch box 8 associated with the processor element. The address table 8b outputs address information of a processor element 2 to which data should be sent subsequently, on the basis of the address information. As for the address information, for example, location information of a processor element 2 to which the packet data should be sent or information which indicates a function to be implemented is used.

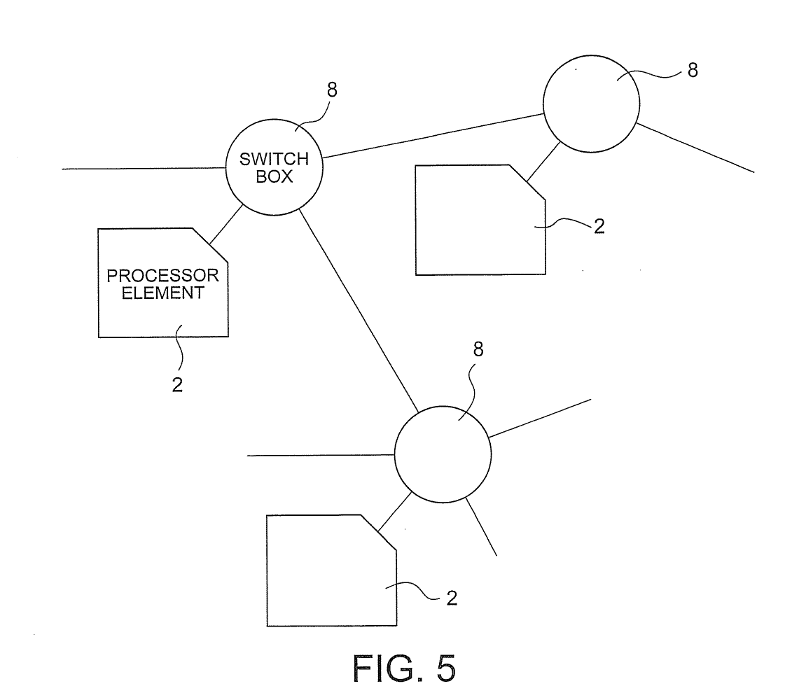

Herein, the network-on-chip means a system configuration in which elements (processor elements 2) for implementing respective functions performs communication respectively via the switch boxes 8 to implement computation or work. Herein, a circuit which performs communication is referred to as switch box as shown in FIG. 5.

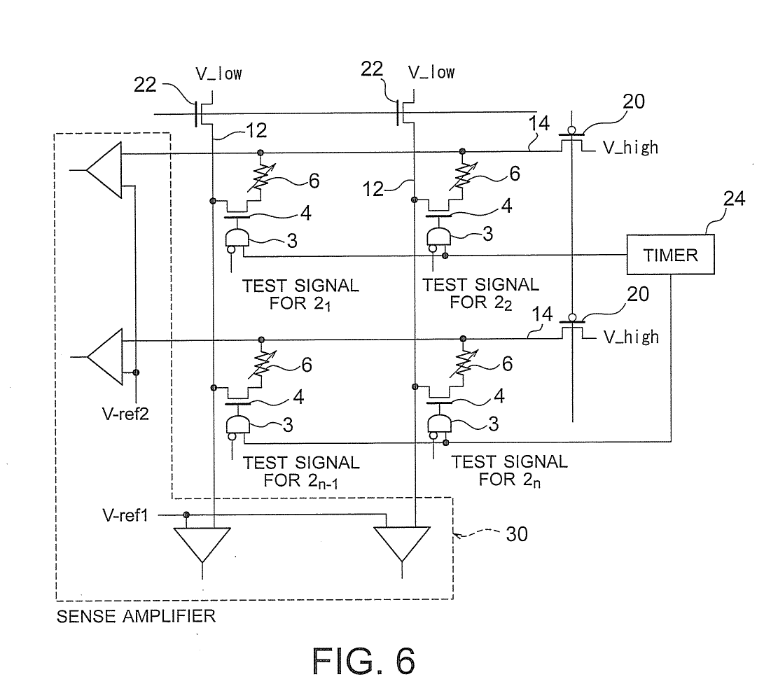

FIG. 6 shows an example of a circuit which identifies a defective processor element 2, i.e., an example of a circuit configuration including the selection transistor 4 and the memory element 6 formed of, for example, a fuse.

The fuse element 6 is not always needed except when tolerance to a plurality of failures described later is provided or when history is recorded. Only the selection transistor 4 may be provided. Each processor element is provided with a number, and an nth processor element is denoted by 2ₙ. A high potential side voltage V_high is applied to first ends of fuse elements 6 via a p-type MOSFET 20. A low potential side voltage V_low is applied to first ends of selection transistors 4 via an n-type MOSFET 22. By the way, the relations of application locations of the high voltage V_high and the low voltage V_low may be reversed. In other words, the high voltage V_high may be applied to the first ends of selection transistors 4 via a MOSFET and the low voltage V_low may be applied to first ends of fuse elements 6 via a MOSFET. In this case, it is desirable to connect the p-type MOSFET 20 to the high voltage V_high and connect the n-type MOSFET 22 to the low voltage V_low. A timer 24 is shown in FIG. 6. This timer 24 determines a test time of the processor element. The test time is determined by, for example, rise of a pulse output from the timer 24 to “1” at the end of the test execution time. Its circuit operation will now be described. If a signal is not obtained from the test circuit 2c until immediately after the end of the test time (i.e., immediately after the rise of the pulse to “1”), then a processor element subjected to the test is judged to be defective and the selection transistor 4 is turned on. If the selection transistor 4 turns on, a current flows between the high voltage V_high and the low voltage V_low via the wire 14, the fuse element 6, the selection transistor 4 and the wire 12, and the voltage on the wire 14 falls whereas the voltage on the wire 12 rises. The voltage change is read, and location information of a wire on which the voltage change has caused becomes location information of the defective processor element. In some cases, those voltage changes are amplified by sense amplifiers 30 and read to detect the location information of the defective processor element. In the sense amplifiers 30 shown in FIG. 6, the voltage change on the wire 12 is compared with a reference voltage V-ref1 and the voltage change on the wire 14 is compared with a reference voltage V-ref2. The location information of them is input to the transmission circuit 10, and translated to address information of the defective processor element. In FIG. 6, an AND circuit 3 is used as a circuit for turning on the selection transistor 4. However, this is used for the sake of convenience, and it is changed depending upon whether the output of the timer 24 or the test circuit 2c is the negative logic or positive logic and whether the selection transistor 4 is a p-type MOSFET or an n-type MOSFET. For example, in the case where test is performed by dividing the inside of the processor element to several regions, the test circuit output becomes a plurality of bits in some cases. In that case, a circuit which combines respective outputs and represents the result as one bit is added. For thus using the AND circuit 3 as the circuit for driving the selection transistor 4 connected to the fuse element 6, the output of the test circuit 2c is always set to an “H” level at the time of normal operation and the output of the test circuit 2c is set to an “L” level at the time of test. If there are no failures according to a result of the test, the output of the test circuit 2c is set to the “H” level again.

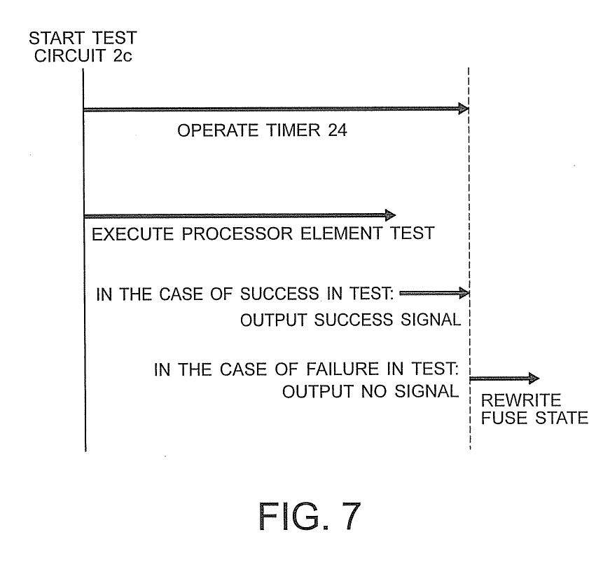

FIG. 7 shows operation timing of the semiconductor integrated circuit according to the present embodiment. If the test circuit 2c is started, the timer 24 starts its operation and begins to count. Typically, the timer 24 can be implemented by using a well known counter circuit. While the timer 24 is operating, the test circuit 2c executes a test on each processor element. If the processor element is judged not to be defective as a result of the test, a test end signal is output. On the contrary, if the processor element is judged to be defective, the signal is not output. Depending upon whether the test end signal is output after a predetermined time is measured by the timer 24, it is finally judged whether the processor element is defective. If the processor element is judged to be defective, the state of the fuse element 6 is rewritten. Here, it has been supposed that the output signal is output when there are no failures whereas the output signal is not output when there is a failure. Alternatively, the relations may be reversed. If the signal is not output when there is a failure, however, the possibility that an abnormality of the test circuit 2c itself can also be detected is high. The signal obtained when the processor element has passed the test may be continued to be always output when the test circuit 2c is not started.

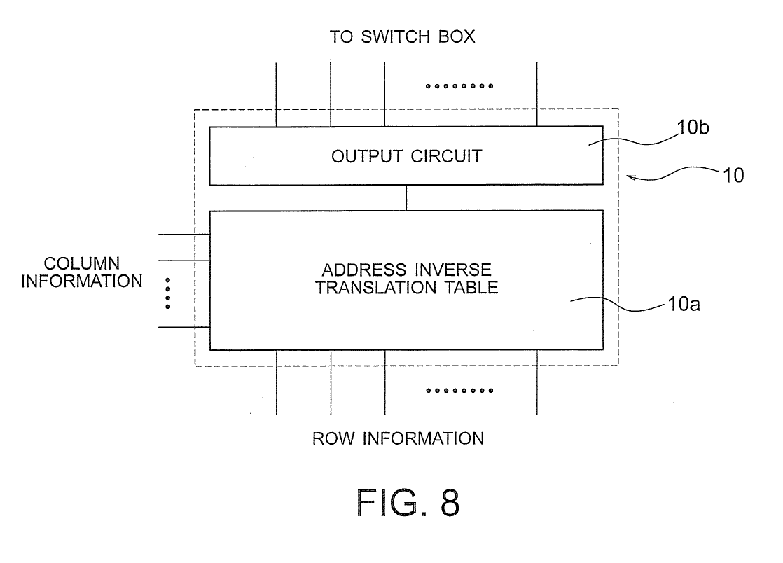

FIG. 8 shows a configuration of the transmission circuit 10. The transmission circuit 10 includes an address inverse translation table 10a and an output circuit 10b. The address inverse translation table 10a translates column information and row information obtained from the selection transistor 4 or the fuse 6 associated with the processor element in one-to-one correspondence to corresponding address information or decoder number in the address table in the switch box. The output circuit 10b is a buffer circuit for outputting contents of the address inverse translation table 10a to respective switch boxes. Upon receiving data from the transmission circuit 10, the switch box acquires failure information by recording failure information in its own address table on the basis of the received data or recording a flag which indicates a failure.

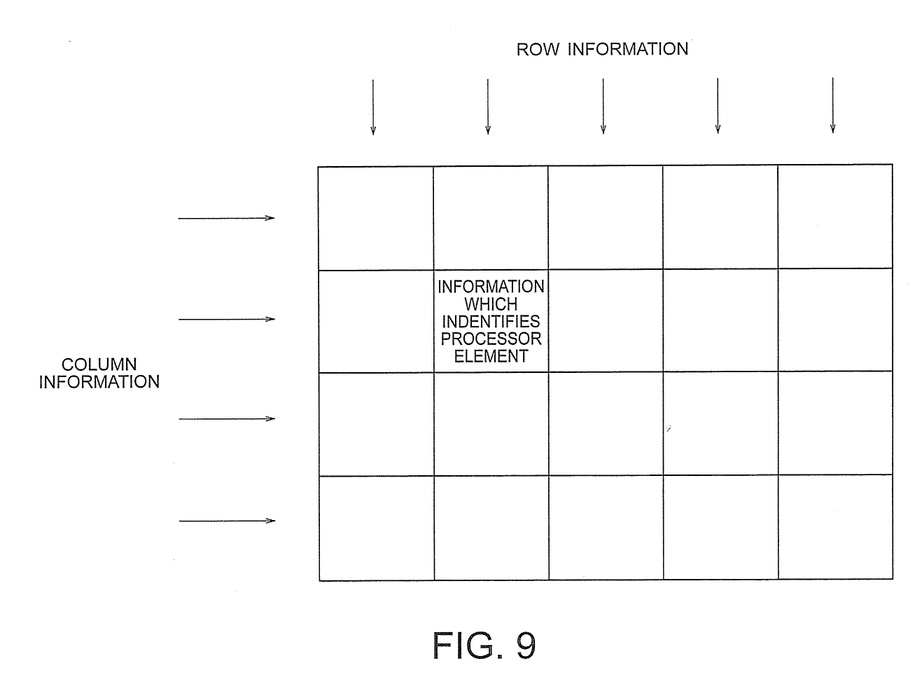

FIG. 9 is a diagram showing the address inverse translation table 10a schematically. If column information and row information obtained from the selection transistor 4 or the fuse 6 associated with the processor element in one-to-one correspondence are input to the address inverse translation table 10a, then data recorded at a crosspoint of the column information and the row information becomes address information used in the address table 8b connected to each processor element according to a configuration of the address inverse translation table 10a. For example, when a serial number is assigned to every processor element, the column information and row information of each processor element is translated to the serial number by the address inverse translation table 10a. And the serial number constitutes a part of address information. By the way, in the case where the row information and column information are used intact as location information of the processor element 2, the address inverse translation is not performed.

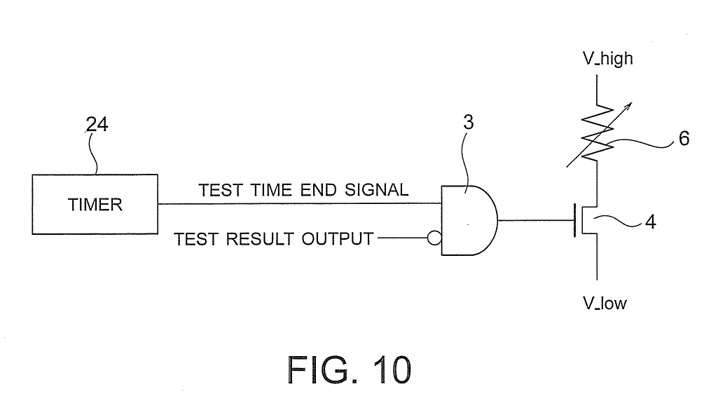

FIG. 10 is a diagram showing an example of a circuit for providing tolerance to a plurality of failures, i.e., a circuit including the AND circuit 3, the selection transistor 4, the memory element 6 formed of, for example, a fuse, and the timer 24. As the initial state, the fuse element 6 is in the low resistance state (ON state). If there is no failure in the processor element according to a test result, then the selection transistor 4 remains to be OFF and consequently a current does not flow through the fuse element 6. If a failure is found, then the selection transistor 4 turns on and a current flows through the fuse element 6. As a result, a voltage drop occurs to tell the place of the defective processor element. The fuse and its current value are designed so as to cause a change such as destruction of the fuse element 6 resulting in a high resistance state at that current value. In the case where, for example, a memory element of variable resistance type is used instead of the fuse element, the memory element and its current value are designed so as to cause a state change such as turning off and bring the memory element into a high resistance state at the current value. At this time, it is necessary that the state change of the fuse element or the memory element occurs after the sense amplifier 30 or the transmission circuit 10 has acquired the location information of the defective processor element. Therefore, time required for the sense amplifier 30 or the transmission circuit 10 to acquire the location information may be an extent causing the state change of the fuse. If so, the selection transistor 4 turns on because of the defective processor element at the time of the next test as well. In that case, however, a current does not flow because the fuse element or the memory element is high in impedance. In other words, in this configuration, a current flows and a voltage drop occurs only when the processor element becomes defective first. If it is supposed that only one processor element failure occurs in one test, it is possible to cope with the case where a plurality of processor elements become defective in order. In this case, history of defective processor elements is recorded in the transmission circuit 10, the switch box 8, or another place, and processor elements described in the history are set so as not to be used.

A potential difference between the high voltage V_high and the low voltage V_low is set small so as not to rewrite the state of the fuse element 6 when power is turned on in first. While scanning the transistor 4 which selects each fuse element 6 every row or every column, the state of the fuse element 6 is inspected and information of defective processor elements is successively recorded in a history table which is not illustrated. As a result, it is possible to avoid the use of a defective processor element when using the circuit next time. As for a signal for scan, a signal obtained by performing an OR operation on a signal for rewriting the fuse element 6 and a scan signal may be used, and a selection transistor for scan may be provided separately. When the condition of one processor element failure per test is not satisfied, the number of processor elements tested once should be decreased to an extent that the condition is satisfied and the whole test should be divided into a plurality of times. By using fuse elements or memory elements, the area can be reduced. Especially by using a three dimensional structure, the area of the semiconductor integrated circuit can be further reduced.

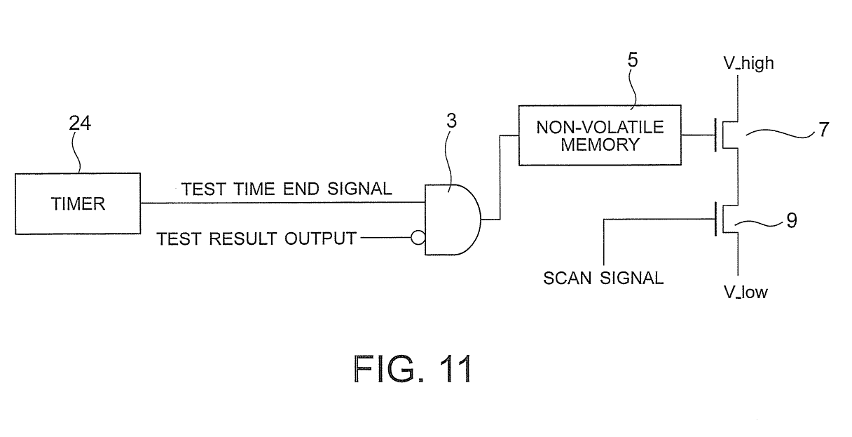

FIG. 11 shows an example implemented by using a different circuit. A transistor 7 is used instead of the fuse element. An output of a test result is recorded in a non-volatile memory 5, and the transistor 7 is driven by the non-volatile memory 5. In this example, another transistor 9 is prepared for a scan signal for a test performed at the time of power turning on. In normal operation, the transistor 9 is always kept in the on-state. A scanned transistor is turned on when performing scan, and other transistors are turned off. The transistor may be an n-type MOSFET or may be a p-type MOSFET. The transistor receives the non-volatile memory 5 or the scan signal at its gate. The non-volatile memory 5 may be a two-terminal memory such as a fuse element, or may be a three-terminal memory such as a flash memory.

According to the present embodiment, a switch element, such as, for example, a transistor, a fuse, or a memory element, associated with each processor element is first provided as heretofore described. If there is a defective processor element, the state of a switch element associated therewith is changed to identify the defective processor element. An address to be erased in the address table in the switch box is recognized on the basis of location information of a defective processor element, and address tables included in all processor elements are rewritten collectively. In other words, a plurality of processor elements can share failure information in a moment. If contents of a table attempted to read out are failure information, the processor element disregards the contents and rereads next information in the address table. As a result, the system can be provided with tolerance to failures.

### Second Embodiment

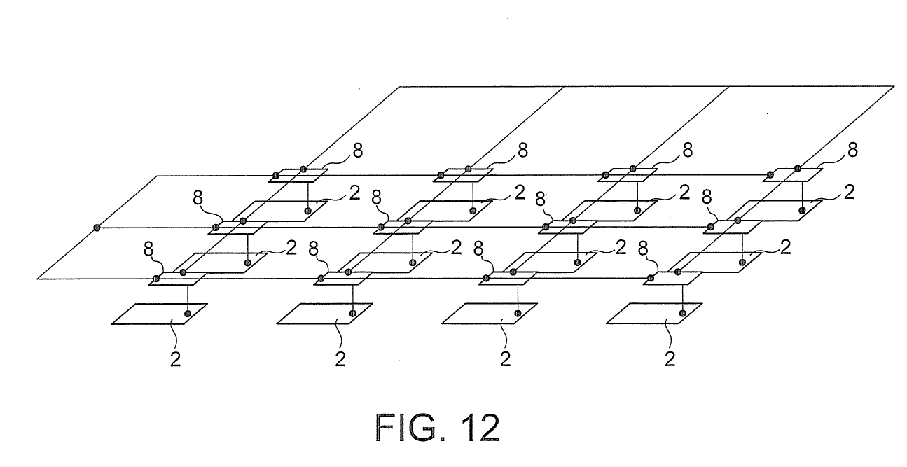

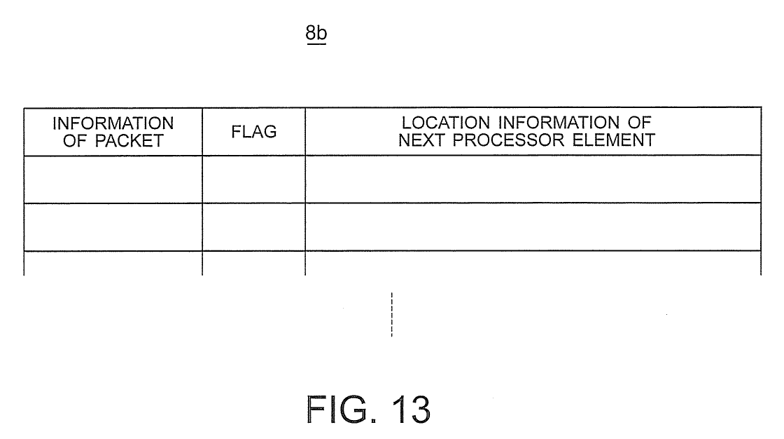

A semiconductor integrated circuit according to a second embodiment of the present invention is shown in FIG. 12. In the semiconductor integrated circuit according to the present embodiment, switch boxes 8 each including an address table which has address information of processor elements 2 are provided right over the processor elements 2 in a three dimensional form. However, the switch boxes 8 need only be associated respectively with the processor elements 2. However, it becomes possible to make the circuit area small and facilitate wiring between address tables by disposing the switch boxes 8 in the three-dimensional form. As shown in FIG. 13, a flag bit indicating whether each processor element 2 is usable is provided in each address table 8b. All gates of selection transistors for controlling the flag bit are connected in common if they correspond to information of the same processor element. FIG. 13 shows an example of a configuration of an address table 8b. For example, if data is acquired on the basis of information added to a packet, location information such as the X coordinate and the Y coordinate of the processor element is obtained. In addition, a flag bit which indicates whether the processor element 2 is usable is added. The flag bit is classified, for example, so as to be usable when the flag bit is “1” and unusable when the flag bit is “0.” As a matter of course, the relations may be reversed. When transmitting data to another processor element, the switch box 8 refers to the address table 8b. If the flag bit is “0” at that time, however, that processor element is not specified and the transmission destination is changed to a different processor element, for example, the next processor element in the address order. In the case where the transmission destination is changed to the next processor element in the address order, however, attention is paid to whether the processor element of transmission is a processor element of the same kind. For example, if the processor element of transmission side is a processor, the processor element of transmission destination is made to be a processor. If the processor element of transmission side is a memory, the processor element of transmission destination is made to be a memory.

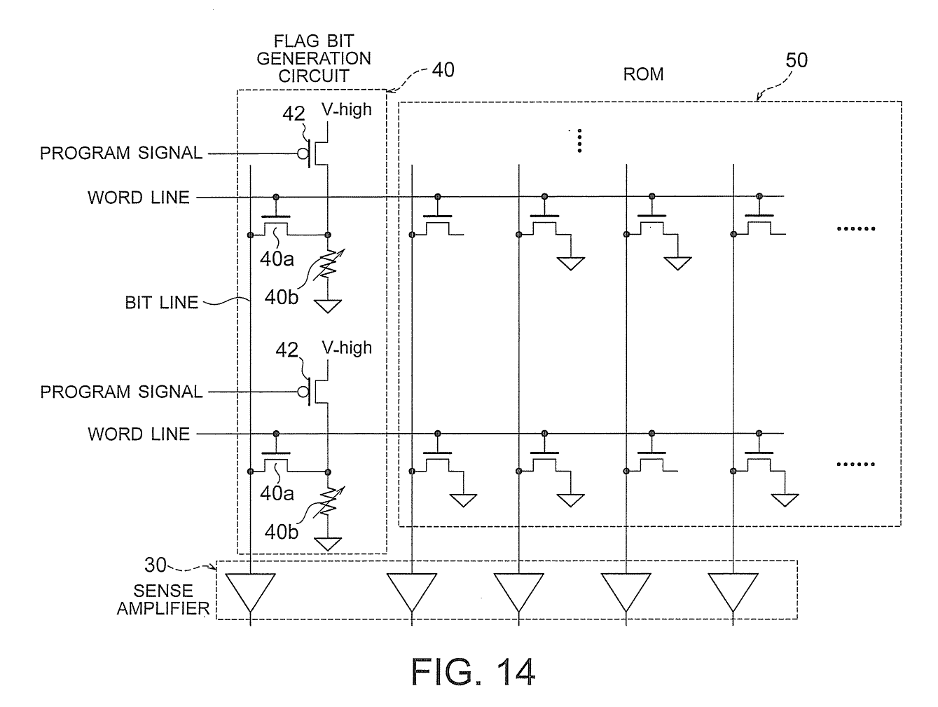

FIG. 14 is a diagram showing an example of a circuit which implements the address table in each switch box 8 according to the present embodiment. A ROM circuit 50 shown in FIG. 14 is a typical ROM circuit. Here, it is sensed whether a transistor serving as a memory element of the ROM circuit is connected at its source to ground. Alternatively, a ROM circuit of a different kind may also be used. Data stored in a memory element connected to one word line in the ROM circuit 50 becomes location information of one processor element. This location information is obtained by providing the word line with, for example, the “H” level and reading out data stored in a memory element connected to this word line by using a sense amplifier 30. A flag bit generation circuit 40 includes a selection transistor 40a, a fuse element 40b, and a program transistor 42 provided so as to be associated with each processor element. The selection transistor 40a is connected at its gate to a word line, connected at its drain to a sense amplifier 30 via a bit line, and connected at its source to a first end of the fuse element 40b. A second end of the fuse element 40b is grounded. The program transistor is a p-type MOSFET which receives a program signal at its gate, which is provided at its drain with the high voltage V_high, and which is connected at its source to the first end of the fuse element 40b. In the present embodiment, this program signal becomes a signal obtained by inverting an output of an AND circuit included in the circuit shown in FIG. 6. In other words, in the present embodiment as well, the timer circuit 24 and the AND circuit 3 shown in FIG. 6 are included.

It is now supposed that the OFF resistance of the transistor 42 has a value between the high resistance state and the low resistance state of the fuse element 40b. When the selection transistor 40a is turned on by the word line in the configuration shown in FIG. 14, a signal having an “L” level is output to the bit line if the fuse element 40b is in its low resistance state whereas a signal having an “H” level is output to the bit line if the fuse element 40b is in its high resistance state. If locations of the transistor 42 and the fuse element 40b are reversed, reversed relations are obtained. If the OFF resistance of the transistor 42 is high regardless of the resistance state of the fuse element 40b, the bit line is precharged to the “H” level. When the selection transistor 40a is turned on by the word line, a change of the voltage on the bit line according to the resistance state of the fuse element 40b is utilized and its difference is read out by the sense amplifier. Information can thus be read out.

The signal indicating the flag bit is read out with the sense amplifier 30 by providing the word line with, for example, the “H” level. At this time, location information of the corresponding processor element is also read out by the sense amplifier 30 simultaneously. A program signal for programming the flag bit generation circuit 40 is made common in address tables in all switch boxes 8. By thus selecting a flag bit implemented using a fuse element with the same word line as that of the ROM 50, the address table can indicate the failure state of the processor element concurrently with the location information of the processor element. Furthermore, the fuse state as it is indicates the failure state of the processor element. Since the fuse state is non-volatile, it is not necessary to perform the scan and read failure information when power is thrown in, unlike the first embodiment.

In the present embodiment, the flag bit generation circuit 40 and the ROM circuit 50 serve as a circuit which identifies a defective processor element.

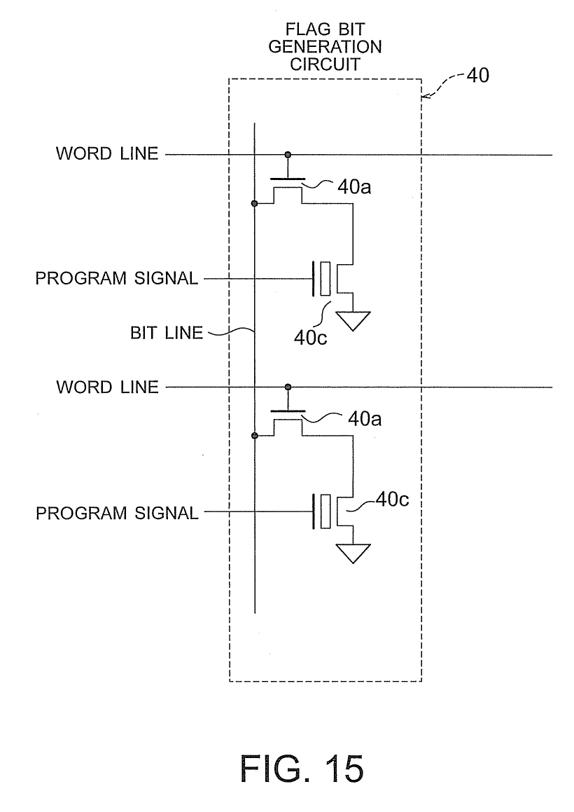

FIG. 15 is a circuit diagram showing another specific example of the flag bit generation circuit 40. The flag bit generation circuit 40 includes a three-terminal floating gate type memory element 40c and a selection transistor 40a connected at its gate to a word line. The selection transistor 40a is connected at its drain to the sense amplifier 30 via the bit line and connected at its source to a first end of the memory element 40c. The memory element 40c is grounded at its second end, and the memory element 40c receives a program signal at its gate. If the bit line is precharged up to a high potential and the selection transistor 40a is turned on, the output becomes an “H” level when the memory element 40c is high in threshold whereas the output becomes an “L” level when the memory element 40c is low in threshold. The threshold state is programmed by a signal generated according to a test result of the processor element. It is arbitrary which of presence or absence of a failure in the processor element is assigned to the high threshold or the low threshold. By the way, it is also possible to connect the second end of the three-terminal memory 40c to the high potential side and precharge the bit line to the “L” level. By causing all switch boxes 8 to share the gates of the memory element 40c which represent the same processor element information, the flag bit can be written collectively. By reading this value, the processor element 2 can judge whether a processor element of transmission destination is defective. Furthermore, the state of the memory element 40c as it is indicates the state of the processor element. Since the memory element 40c is non-volatile, it is unnecessary to perform scan and read failure information when power is thrown in unlike the case of the first embodiment. In this way, the memory which indicates the flag bit and the failure state may also be implemented by using a three-terminal memory element.

According to the embodiments of the present invention, it is possible to share failure information of each element in a moment as heretofore described. As a result, a circuit which is more excellent in tolerance to failures can be fabricated. The above-described embodiments have been described by taking the configuration in which each element has an address table as an example, being conscious of the network-on-chip system. It is possible to consider a use method in which the present invention is applied to a multiprocessor system other than the configuration and the failure table included in each processor is updated in a moment. In this case, an advantage that the system performance lowering is suppressed is obtained because failure information is shared in a moment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A semiconductor integrated circuit comprising:
a plurality of processor elements each comprising a test circuit which tests whether there is a failure in the processor element and outputs a result of the test;
a plurality of switch boxes provided so as to be respectively associated with processor elements, each of the switch boxes configured to have a table to store information of another processor element and transmit information of a corresponding processor element to the other processor element based on information stored in the table;
a plurality of identification circuits provided so as to be respectively associated with processor elements, each of the identification circuits configured to identify a defective processor element on the basis of the result of the test and output location information of the defective processor element; and
a transmission circuit configured to transmit the location information of the defective processor element output from the identification circuit to the switch boxes.

2. The circuit according to claim 1, wherein each of the identification circuits comprises a non-volatile memory element which changes in storage state when the result of the test outputted by the test circuit in the corresponding processor element indicates that there is a failure.

3. The circuit according to claim 2, wherein the memory element is provided right over the corresponding processor element.

4. A semiconductor integrated circuit comprising:
a plurality of processor elements each comprising a test circuit which tests whether there is a failure in the processor element and outputs a result of the test; and
a plurality of switch boxes provided so as to be respectively associated with the processor elements, each of the switch boxes configured to include a table to store information of all the processor elements and an identification circuit to identify a defective processor element based on results of the tests of all the test circuits and send information of the defective processor element to the tables, and each of the switch boxes configured to transmit information of a corresponding processor element to other processor elements based on information stored in the table.

5. The circuit according to claim 4, wherein the identification circuit comprises non-volatile memory elements provided so as to be respectively associated with the processor elements, each of which changes in storage state when the result of the test outputted by the test circuit indicates that there is a failure.

6. The circuit according to claim 4, wherein the table is provided right over the corresponding processor element.

7. The circuit according to claim 4, wherein the identification circuit comprises a ROM which stores location information of the processor elements.
